(19) United States
(12) Patent Application Publication
(10) Pub. No.: US 2017/0193794 A1
(43) Pub. Date: Jul. 6, 2017

(54) Water Heaters and Methods for Monitoring Anode Rod Depletion

(71) Applicant: General Electric Company, Schenectady, NY (US)

(72) Inventors: Brett Alan Farris, Louisville, KY (US); Michelle Diana Gross, Louisville, KY (US)

(21) Appl. No.: 14/988,810

(22) Filed: Jan. 6, 2016

(51) Int. Cl. G08B 21/18; F24H 9/20; F24H 9/00

(52) U.S. Cl. CPC G08B 21/182; F24H 9/0047; F24H 9/2021

(57) ABSTRACT

Water heaters and methods for monitoring anode rod depletion in water heaters are provided. A water heater includes a tank for holding a volume of water, and an anode rod extending into the water and electrically connected to an electrical ground such that a galvanic current flows from the anode rod to the electrical ground. The water heater further includes at least one heating element configured to heat the water when energized, and a controller. The controller is configured to receive a galvanic current level, compare the galvanic current level to a threshold current level, and transmit an alert signal when the galvanic current level is less than the threshold current level.

### FIELD OF THE INVENTION

The present disclosure relates generally to water heaters, and more particularly to apparatus and methods for monitoring anode rod depletion in water heaters.

### BACKGROUND OF THE INVENTION

Most modern water heaters are constructed of a steel tank with a glass lining. Passive anode rods are a vital component to water heaters utilizing a steel tank or other forms of tanks susceptible to corrosion. An anode rod can act as a sacrificial anode that provides protection against tank corrosion. In particular, the anode rod acts as a sacrificial anode by way of galvanic corrosion.

As a result of the galvanic corrosion, a galvanic current can flow from the anode rod to a cathode to which the anode rod is electrically connected. The cathode is commonly the exterior of the tank connected to an earth ground. As the galvanic current is a result of the galvanic corrosion, greater corrosion results in greater galvanic current and vice versa.

One issue with many water heaters which utilize anode rods is monitoring of the anode rods and replacing of the anode rods when they are depleted. Once an anode rod is depleted, the water tank may begin to corrode, potentially causing damage to the water tank and water leakage from the water tank. Consumers may not be aware of the life of the anode rod utilized in their water heater, and may not sufficiently monitor the anode rod and replace the anode rod before depletion and water tank corrosion has begun.

Accordingly, improved water heaters and methods for monitoring anode rod depletion in water heaters are desired. In particular, water heaters and methods which provide sufficient depletion warnings to consumers would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a water heater is provided. The water heater includes a tank for holding a volume of water, and an anode rod extending into the water and electrically connected to an electrical ground such that a galvanic current flows from the anode rod to the electrical ground. The water heater further includes at least one heating element configured to heat the water when energized, and a controller. The controller is configured to receive a galvanic current level, compare the galvanic current level to a threshold current level, and transmit an alert signal when the galvanic current level is less than the threshold current level.

In accordance with another embodiment of the present disclosure, a methods for monitoring anode rod depletion in a water heater is provided. The method includes receiving a galvanic current level flowing from the anode rod to an electrical ground, the anode rod extending into a volume of water disposed within a tank of the water heater. The method further includes comparing the galvanic current level to a threshold current level, and transmitting an alert signal when the galvanic current level is less than the threshold current level.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an exemplary water heating system according to an exemplary embodiment of the present disclosure;

FIG. 2 depicts a cross-sectional view of an exemplary anode rod according to an exemplary embodiment of the present disclosure; and

FIG. 3 depicts a flowchart of an exemplary method for monitoring anode rod depletion in a water heater according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

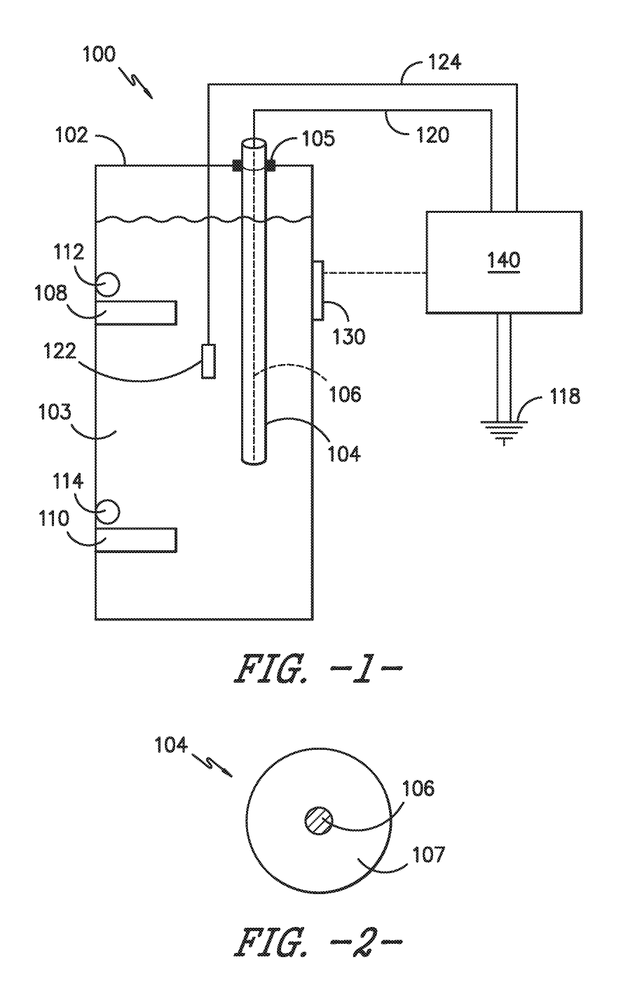

FIG. 1 depicts an exemplary water heating system or water heater 100 according to an exemplary embodiment of the present disclosure. Water heating system 100 can include tank 102 that holds a volume of water 103. An anode rod 104 can pass through an opening at the top of tank 102 and extend downwards into water 103. For example, anode rod 104 can be mounted to tank 102 at the opening Where anode rod 104 enters tank 102. Anode rod 104 can be isolated from direct electrical connection to tank 102 by means of an insulated cap or liner 105 placed between anode rod 104 and tank 102 at the place of mounting.

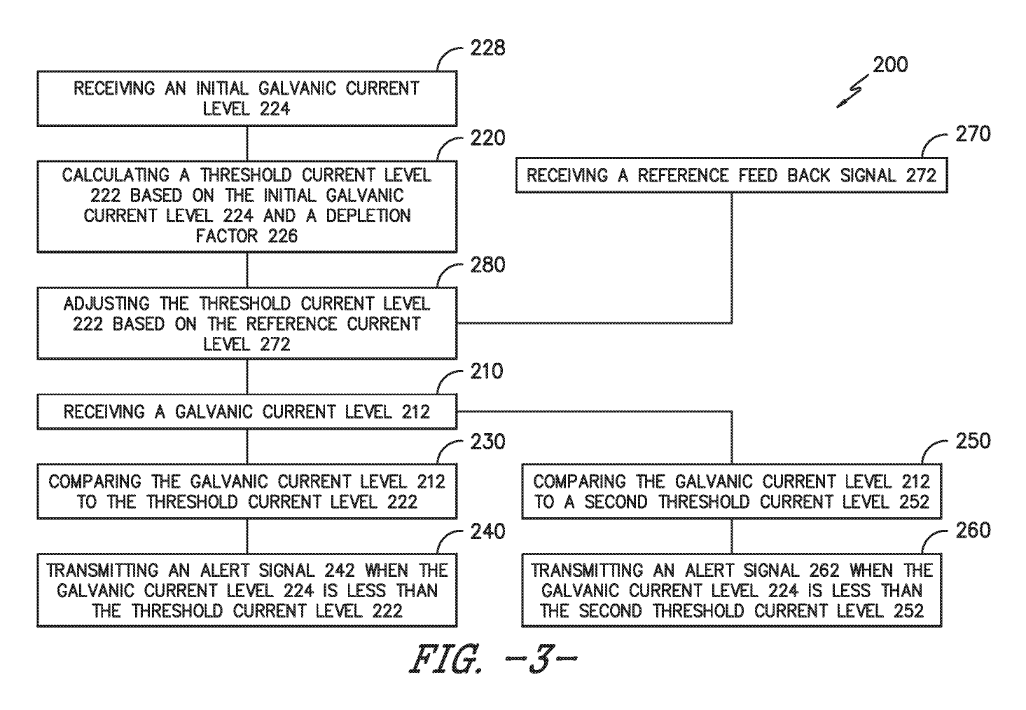

With reference to FIG. 2, a cross-sectional view of an exemplary anode rod 104 according to an exemplary embodiment of the present disclosure is depicted. Anode rod 104 can have a core 106 and an outer region 107. Core 106 can extend coaxially with outer region 208 throughout anode rod 104 such that core region 106 is coaxially surrounded by outer region 208. The configuration provided is exemplary in nature and other suitable configurations can be used.

Outer region 208 can be made of any suitable material. For example, outer region 208 can be made of magnesium, aluminum, or an aluminum-zinc alloy. Core 106 can be made of any conductive material. As an example, core 106 can be a conductive wire, such as, for example, a steel wire.

Returning to FIG. 1, water heating system 100 can further include a first heating element 108 and a second heating element 110. First and second heating elements 108 and 110 can be attached to an interior of tank 102. For example, heating elements 108 and 110 can be disposed at different heights within tank 102.

Heating elements 108 and 110 can be configured to heat water 103 when energized. As an example, heating elements 108 can 110 can be resistance heating elements which generate heat by resisting an electric current. However, heating elements 108 and 110 can each be any suitable device, structure, or circuit for generating heat to raise the temperature of water 103, such as a sealed heat pump system, etc.

Water heating system 100 can further include temperature sensors 112 and 114. Temperature sensors 112 and 114 can be positioned inside the tank proximate to heating elements 108 and 110. In particular, temperature sensor 112 can be positioned proximate to heating element 108 while temperature sensor 114 can be positioned proximate to 110.

Temperature sensors 112 and 114 can respectively provide a temperature signal describing a temperature in their respective local regions. For example, temperature sensor 112 can provide a temperature signal describing an ambient temperature about sensor 112. As an example, temperature sensors 112 and 114 can be thermistors.

According to embodiments of the present disclosure, anode rod 104 can act as a sacrificial anode to protect the interior of tank 102 from corrosion. In particular, anode rod 104 can suffer galvanic corrosion in place of tank 102. Such galvanic corrosion can generate a galvanic current flowing from anode rod 104 to an electrical ground 118. Electrical ground 118 can be the exterior of the tank 102 which is connected to an earth ground.

The galvanic current can flow from anode rod 104 to electrical ground 118 by way of electrical conductor 120. For example, electrical conductor 120 can be connected to core 106 of anode rod 104. Electrical conductor 120 can be made of any suitable conductive material and can include one or more wires, filters, or other suitable components.

Water heater 100 can further include a reference probe 122 which may be positioned inside tank 102 and may extend into and thus be in contact with water 103. Reference probe 122 may be formed from a conductive material, such as for example from a silver chloride. Similar to the anode rod 104, the reference probe 122 can be isolated from direct electrical connection to tank 102, and a reference feedback signal can be generated which flows from the reference probe 122 to the electrical ground 118 (at the same or similar location as the galvanic current). The reference feedback signal can be a reference current, reference voltage, etc. The reference feedback signal can flow from reference probe 122 to electrical ground 118 by way of electrical conductor 124. For example, electrical conductor 124 can be connected to reference probe 122. Electrical conductor 124 can be made of any suitable conductive material and can include one or more wires, filters, or other suitable components.

Water heater 100 may additionally include a user interface 130. User interface 130 may generally allow a user to interact with the water heater 100. For example, user interface 130 can be any suitable device or components for collecting information from a user and/or sending and receiving information from a controller. In exemplary embodiments, user interface 130 may receive information from the controller and output a visual or audio display based on the information. User interface 130 may include, for example, one or more lights, speakers and/or screens which provide textual displays,

As mentioned, water heater 100 may additionally include a controller 140. Controller 140, such as a control circuit thereof, may be electrically connected to the electrical conductor(s) 120, 124, and may thus receive and process electric signals (i.e. current levels) flowing through the electrical conductor(s) 120, 124. Controller 140 may additionally, for example, be in communication with heating elements 108, 110 for activating and deactivating the heating elements 108, 110, and may further be in communication with temperature sensors 112, 114 for receiving temperature levels therefrom.

Controller 140 can be any suitable computing device and can include one or more processors, a memory, or other suitable components. In particular, the memory can store computer-readable instructions that are executed by the processor in order to perform one or more algorithms. In some implementations, controller 140 is an application specific integrated circuit.

Controller 140 can send and receive signals with anode rod 104 (through electrical conductor 120), probe 122 (through electrical conductor 120) and user interface 130. Accordingly, controller 140 can receive galvanic current levels and reference feedback signals, and can transmit alert signals, as discussed herein. The current levels can be continuously transmitted to and received by the controller 140, or controller 140 can provide queries, read the signals, or provide prompts at specific instances.

Controller 140 in exemplary embodiments is configured to compare various current levels and, when necessary, transmit alert signals, The alert signals which are generated by the controller 140 may generally indicate that the anode rod 104 has depleted to a particular extent, and that replacement of the anode rod is desirable. Accordingly, consumers may advantageously be alerted to such anode rod depletion and given opportunities to replace the anode rod before corrosion and resulting damage to the water heater tank 102 begins to occur.

Referring additionally now to FIG. 3, the present disclosure is further directed to methods 200 for monitoring anode rod 104 depletion in water heaters 100. In exemplary embodiments, controller 140 may be configured to perform the various methods steps as discussed herein.

For example, method 200 may include the step 210 of receiving a galvanic current level 212 flowing from the anode rod 104, as discussed above. The galvanic current level 212 that is received may, for example, be a level that is received at a singular time, or may be an average level over a period of time. For example controller 140 may receive levels over a period of time and subsequently calculate the average level which is to be utilized as galvanic current level 202.

Method 200 may further include, for example, the step 220 of comparing the galvanic current level 212 to a threshold current level 222 (which may be a first threshold current level 222, as discussed herein). In some embodiments, the threshold current level 222 may be a predetermined threshold current level, and may thus for example be stored in the controller 140. For example, the predetermined threshold current level may be between 1 milliamp and 1.5 milliamps, such as between 1.1 milliamps and 1.4 milliamps, such as 1.2 milliamps.

In alternative embodiments, the threshold current level 222 may be calculated based on particular variables for the water heater 100. For example, the threshold current level 222 may be calculated based on an initial galvanic current level 224 that is received and a depletion factor 226. Method 200 may thus include the step 228 of receiving the initial galvanic current level 224 before receipt of the galvanic current level 212, and may further include the step 230 of calculating the threshold current level 222 based on the initial galvanic current level 224 and the depletion factor 226.

The initial galvanic current level 224 is a galvanic current level flowing from the anode rod 104 that is received before receipt of any galvanic current level 212. For example, the initial galvanic current level may be a level that is received initially when the water heater 100 is installed and/or the present anode rod 104 is installed in the water heater 100. This initial galvanic current level 224 may be utilized as a baseline galvanic current level by which depletion of the anode rod 104 may be monitored, based on comparisons between the initial galvanic current level 224 and subsequent galvanic current levels 212. The depletion factor 226 is a predetermined percentage which may be utilized to adjust the initial galvanic current level 224 and thus determine the threshold current level 222. For example, the depletion factor 226 may be between 10% and 30%, such as between 15% and 25%, such as 20%. A 20% depletion factor 226 may, for example, approximately correspond with 80% depletion of the anode rod 104. Accordingly, the initial galvanic current level 224 may for example be multiplied by the depletion factor 226 to calculate the threshold current level 222.

Method 200 may further include, for example, the step 240 of transmitting an alert signal 242 (which may be a first alert signal, as discussed herein). The alert signal 242 may be transmitted, such as from the controller 140, when the galvanic current level 224 is less than the threshold current level 222. The galvanic current level 224 being less than the threshold current level 222 may generally indicate that the anode rod 104 has depleted to a level wherein the consumer should consider replacing the anode rod 104. The alert signal 242 which is transmitted in accordance with step 240 may alert the consumer to this situation.

The alert signal 242 may in some embodiments be sent to the user interface 130. User interface 130 may, for example, receive the alert signal 242 and output an alert based on the alert signal 242. The alert may, for example, be a textual display alerting a consumer to consider changing the anode rod 104, or may be another visual indicator such as a light or an audible indicator such as a beep, chime, siren, etc.

In some embodiments, method 200 may further include, for example, the step 250 of comparing the galvanic current level 212 to a second threshold current level 252. The second threshold current level 252 may be less than the first threshold current level 222.

In some embodiments, the second threshold current level 252 may be a predetermined threshold current level, and may thus for example be stored in the controller 140. For example, the predetermined threshold current level may be between 0.3 milliamps and 0.7 milliamps, such as between 0.4 milliamps and 0.6 milliamps, such as 0.5 milliamps.

In alternative embodiments, the second threshold current level 252 may be calculated based on particular variables for the water heater 100. For example, the second threshold current level 252 may be calculated based on the initial galvanic current level 224 that is received and a secondary depletion factor, similar to calculation of the first threshold current level 222 as discussed above. Method 200 may thus include the step of calculating the second threshold current level 252 based on the initial galvanic current level 224 and the secondary depletion factor. The secondary depletion factor may be a predetermined percentage which may be utilized to adjust the initial galvanic current level 224 and thus determine the second threshold current level 252. For example, the secondary depletion factor may be between 2% and 8%, such as between 4% and 6%, such as 5%. A 5% depletion factor may, for example, approximately correspond with 95% depletion of the anode rod 104. Accordingly, the initial galvanic current level 224 may for example be multiplied by the secondary depletion factor to calculate the second threshold current level 252.

Method 200 may further include, for example, the step 260 of transmitting a second alert signal 262. The second alert signal 262 may be transmitted, such as from the controller 140, when the galvanic current level 224 is less than the second threshold current level 252. The galvanic current level 224 being less than the second threshold current level 252 may generally indicate that the anode rod 104 has depleted to a level wherein replacing the anode rod 104 is urgent and needs to be done soon in order to avoid water tank 102 corrosion, etc. The alert signal 262 which is transmitted in accordance with step 260 may alert the consumer to this situation.

The alert signal 262 may in some embodiments be sent to the user interface 130. User interface 130 may, for example, receive the alert signal 262 and output an alert based on the alert signal 262. The alert may, for example, be a textual display alerting a consumer to consider changing the anode rod 104, or may be another visual indicator such as a light or an audible indicator such as a beep, chime, siren, etc. In exemplary embodiments, the second alert signal 262 may be different from the first alert signal 242. The second alert signal 262 may, for example, indicate the increased urgency for replacing the anode rod 104. Accordingly, the textual display may be different, or the visual indicator may be brighter, of a different color, or a different indicator, or the audible indicator may be louder, a different noise, etc.

As discussed above, in some embodiments, a reference probe 122 may be provided, and a reference feedback signal may flow from the reference probe 122. Method 200 in some embodiments may thus further include the step 270 of receiving a reference feedback signal 272 flowing from the reference probe 122. The reference feedback signal 272 that is received may, for example, be a signal that is received at a singular time, or may be an average level over a period of time. For example controller 140 may receive levels over a period of time and subsequently calculate the average level which is to be utilized as reference feedback signal 272.

Method 200 may further include, for example, the step 280 of adjusting the threshold current level(s) 222, 252 based on the reference feedback signal 272. For example, if the reference feedback signal 272 is particularly high or low, i.e. above or below a predetermined threshold, etc. (depending on the particular feedback signal being utilized), the threshold current level(s) 222, 252 may be increased, and vice versa. Use of reference feedback signal 272 in accordance with the present disclosure may allow for tailoring of threshold current level(s) 222, 252 to the particular environment (including the water 103 in tank 102) in which the water heater 100 is situated.

it should additionally he understood that the various thresholds as discussed herein, such as the threshold current level(s) 222, 252, may be chosen and/or adjusted based on other factors including, for example, anode rod 104 size, tank 102 size, tank 102 material, internal tank 102 protection coating, etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water heater, comprising:
a tank for holding a volume of water;
an anode rod extending into the water and electrically connected to an electrical ground such that a galvanic current flows from the anode rod to the electrical ground;
at least one heating element configured to heat the water when energized; and
a controller, the controller configured to:
receive a galvanic current level;
compare the galvanic current level to a threshold current level; and
transmit an alert signal when the galvanic current level is less than the threshold current level.

2. The water heater of claim 1, wherein the threshold current level is a predetermined threshold current level.

3. The water heater of claim 2, wherein the predetermined threshold current level is between 1 milliamp and 1.5 milliamps.

4. The water heater of claim 1, wherein the controller is further configured to:
receive an initial galvanic current level before receipt of the galvanic current level; and
calculate the threshold current e based on the initial galvanic current level and a depletion factor.

5. The water heater of claim 4, wherein the depletion factor is between 10% and 30%.

6. The water heater of claim 1, wherein the threshold current level is a first threshold current level and the alert, signal is a first alert signal, and wherein the controller is further configured to:
compare the galvanic current level to a second threshold current level, the second threshold current level less than the first threshold current level; and
transmit a second alert signal when the galvanic current level is less than the second threshold current level.

7. The water heater of claim 6, wherein the second alert signal is different from the first alert signal.

8. The water heater of claim 6, wherein the second threshold current level is a predetermined threshold current level.

9. The water heater of claim 8, wherein the predetermined threshold current level is between 0.3 milliamp and 0.7 milliamps.

10. The water heater of claim 1, further comprising a reference probe, the reference probe extending into the water and electrically connected to the electrical ground.

11. The water heater of claim 10, wherein the controller is configured to:
receive a reference feedback signal; and
adjust the threshold current level based on the reference feedback signal.

12. A method for monitoring anode rod depletion in a water heater, the method comprising:
receiving a galvanic current level flowing from the anode rod to an electrical ground, the anode rod extending into a volume of water disposed within a tank of the water heater,
comparing the galvanic current level to a threshold current level; and
transmitting an alert signal when the galvanic current level is less than the threshold current level.

13. The method of claim 12, wherein the threshold current level is a predetermined threshold current level.

14. The method of claim 12, further comprising:
receiving an initial galvanic current level before receipt of the galvanic current level; and
calculating the threshold current level based on the initial galvanic current level and a depletion factor.

15. The method of claim 14, wherein the depletion factor is between 10% and 30%.

16. The method of claim 12, wherein the threshold current level is a first threshold current level and the alert signal is a first alert signal, and further comprising:
comparing the galvanic current level to a second threshold current level, the second threshold current level less than the first threshold current level; and
transmitting a second alert signal when the galvanic current level is less than the second threshold current level.

17. The method of claim 16, wherein the second alert signal s different from the first alert signal.

18. The method of claim 16, wherein the second threshold currents a predetermined threshold current level.

19. The method of claim 12, further comprising receiving a reference feedback signal flowing from a reference probe to the electrical ground, the reference probe extending into the volume of water.

20. The method of claim 19, further comprising adjusting the threshold current level based on the reference feedback signal.
